(19) United States
(12) Patent Application Publication
(10) Pub. No.: US 2014/0278547 A1
(43) Pub. Date: Sep. 18, 2014

(54) System and Method For Healthcare Outcome Predictions Using Medical History Categorical Data

(71) Applicant: Opera Solutions, LLC, Jersey City, NJ (US)

(72) Inventors: Steve Wickert, Oceanside, CA (US); Mona Mahmoudi, San Diego, CA (US); Wenlan Zhang, Shanghai (CN)

(73) Assignee: Opera Solutions, LLC, Jersey City, NJ (US)

(21) Appl. No.: 14/206,372

(22) Filed: Mar. 12, 2014

Related U.S. Application Data
(60) Provisional application No. 61/783,430, filed on Mar. 14, 2013.

(51) Int. Cl. G06F 19/00

(52) U.S. Cl. CPC G06F 19/3431
USPC 705/3

(57) ABSTRACT

A system and method for healthcare outcome predictions using medical history categorical data is provided. The system for healthcare outcome predictions using medical history categorical data comprising a computer system for receiving medical history categorical data, a healthcare outcome prediction engine stored on the computer system which, when executed by the computer system, causes the computer system to process the medical history categorical data to define a set of high-level constructs, calculate smoothed and thresholded Weight of Evidence tables for each high-level construct using training data, calculate an Evidence Ranked Sum value for each instance of each high-level construct based on the Weight of Evidence tables, and build predictive models based on the calculated Evidence Ranked Sum values.

### CROSS-REFERENCE TO RELATED APPLICATION

This application claims priority to U.S. Provisional Patent Application No. 61/783,430 filed on Mar. 14, 2013, which is incorporated herein by reference in its entirety.

### BACKGROUND

1. Field of the Disclosure

The present disclosure relates generally to systems and methods for predictive modeling of patient healthcare using medical information. More specifically, the present disclosure relates to systems and methods for healthcare outcome predictions using medical history categorical data.

2. Related Art

A patient's historical medical records contain information useful for predicting future healthcare outcomes for that patient. Comprehensive medical history consists of diverse sources including medical procedures, diagnoses, prescription medications, and many others. Much of that information is in the form of categorical data (e.g., each individual data field takes on values from an enumerated list of possible values). Prominent examples are ICD9 diagnostic and procedure codes, and numeric drug class descriptors. However, given a set of diverse categorical medical records for a patient, it is far from obvious how to optimally extract information having predictive value for a desired target.

Much of the information is time-dependent, but existing methods do not take this into account. Existing methods for handling categorical data rely on domain knowledge and typically involve binary indicator flags for a set of hand-chosen values of a categorical field in the raw data. These hand-chosen values represent those that a knowledgeable researcher suspects might be predictive of the target, but this approach will miss important ones because it is not driven by the data. A binary indicator flag for the value v1 of categorical field f1 would take the value “1” if f1 has value v1, and “0” if f1 has any other value. In existing practice, there is one indicator flag for each possible value of each field in the set chosen. The set of indicator flags is then used as input to a predictive model. It is not necessary that each of the initially hand-chosen indicator flags have strong predictive information for the target, as various methods of modelling variable selection could be used to filter out unimportant ones and select those that are most informative.

This existing approach has severe limitations. Most of the categorical fields that are important in healthcare data, such as ICD9 diagnostic and procedure codes, have thousands of possible values. It is unwieldy and ineffective to start variable selection with so many candidate variables. In practice, one uses domain knowledge and heuristics to arrive at a small set of indicator flags that a researcher knowledgeable in the field suspects may have outsized predictive value for the target, but the selection of this set is not informed by the data.

### SUMMARY

The present disclosure relates to systems and methods for healthcare outcome predictions using medical history categorical data. More specifically, the present disclosure relates to a system and method for estimating probabilities of healthcare outcomes using categorical data in patient medical records. Identification of patients who are at an elevated risk of future preventable, treatable conditions (e.g., diabetes, high cholesterol, high blood pressure, osteoporosis, pneumonia, hospital acquired infection, hospital readmission, etc.) allows timely intervention, leading to reduced healthcare costs and improved patient health. The system also allows prediction of other outcomes such as ER admission, need for surgery, and high medical costs and other economic factors which are valuable to healthcare providers and others.

The system defines and uses a set of high-level constructs built from the underlying data. These constructs can be and usually are time-dependent, take advantage of implicit structure in the underlying data including hierarchical structure, and easily and naturally incorporate complex information such as reporting latencies that vary from record to record according to some known logic. The method includes constructing smoothed and thresholded Weight of Evidence (WoE) tables for each defined high-level construct.

The system includes an Evidence Ranked Sum (ERS) method, which describes how to calculate a single scalar value, using WoE tables, for each instance of each high-level construct in the data. These continuous scalar values distill in one place all of the contributions to the target prediction from a variable number of records in the underlying data, and comprehensively and systematically capture all of the target information from all of the field values that are marginally but significantly predictive. The ERS method provides a new set of continuous values, distilled from the primary categorical underlying data, that are then used to build a predictive model using established techniques such as logistic regression, neural networks, support vector machines, etc. Existing methods rely on the domain knowledge of a researcher and are not data-driven.

### BRIEF DESCRIPTION OF THE DRAWINGS

The foregoing features of the disclosure will be apparent from the following Detailed Description, taken in connection with the accompanying drawings, in which:

FIG. 1 is a diagram illustrating the system of the present disclosure;

FIG. 2 is a flowchart illustrating processing steps carried out by the system;

FIGS. 3-6 are diagrams illustrating medical events and modeling events carried out by the system of the present disclosure; and

FIG. 7 is a diagram showing hardware and software components of the system.

### DETAILED DESCRIPTION

The present disclosure relates to systems and methods for healthcare outcome predictions using medical history categorical data, as discussed in detail below in connection with FIGS. 1-7. This disclosure describes a scoring system and method for estimating probabilities of healthcare outcomes using categorical data in patient medical records. Focusing on a limited time window works well because relevant information is concentrated within the time window and inclusion of data outside that time window would dilute the predictive power of the information within it. The high-level constructs described herein take this important consideration into account.

Another important feature of the high-level constructs described in this disclosure is that they capture structural information implicit in the underlying data. For instance, the raw data may record a variable number of ICD9 diagnostic codes for a particular medical procedure, but the first position in the list may be reserved for the patient's reported symptoms, while the second is reserved for the doctor's diagnosis.

These high-level constructs can also capture implicit structure/information (e.g., hierarchical structure/information) present in the underlying data. These high-level constructs easily and naturally incorporate complex information such as reporting latencies that vary from record to record according to some known logic. Existing techniques provide no way to capture this information. For instance, patient residence and medical facility ZIP codes are hierarchically organized from the leftmost to rightmost digits, allowing simultaneous capture of information at different levels in a comprehensive set of high-level constructs. The underlying data may also contain prescription drug classification descriptors that are hierarchical, allowing simultaneous capture, in different high-level constructs, of both broad drug class and specific medications. The categorical data (e.g., medical history categorical data) could include hierarchical drug classification tags, patient demographic categorical data (e.g., gender, age, marriage status, etc.), treatment center types, patient residence and hospital ZIP codes, etc.

An important contribution of this disclosure is that it provides a data-driven method for systematically identifying all categorical data values that have predictive power for the target, including the full set of those with moderate but significant power. The advantage of ERS is that it comprehensively and systematically sifts all possible values of the categorical fields in the underlying data and distills all of the information present in the large set of field values that are marginally but significantly informative about the target. While existing methods might leverage a restricted set of indicator flags, the methods described in this disclosure leverage a full set of smoothed, thresholded WoE tables, one for each high-level construct, each typically containing hundreds of entries if the underlying fields are ICD9 diagnostic and procedure codes, for example. Existing methods for working with complex categorical data have no way to handle the highly variable number of records typically found between different patients. The methods described in this disclosure, particularly those called ERS, effectively normalize away this variability and allow all patients to be scored and ranked by risk relative to one another. Additionally, the method constructs smoothed and thresholded WoE tables for each defined high-level construct.

FIG. 1 is a diagram showing a system for healthcare outcome predictions using medical history categorical data, indicated generally at 10. The system 10 comprises a computer system 12 (e.g., a server) having a database 14 stored therein and healthcare outcome prediction engine 16. The computer system 12 could be any suitable computer server (e.g., a server with an INTEL microprocessor, multiple processors, multiple processing cores) running any suitable operating system (e.g., Windows by Microsoft, Linux, etc.). The database 14 could be stored on the computer system 12, or located externally (e.g., in a separate database server in communication with the system 10).

The system 10 could be web-based and remotely accessible such that the system 10 communicates through a network 20 with one or more of a variety of computer systems 22 (e.g., personal computer system 26a, a smart cellular telephone 26b, a tablet computer 26c, or other devices). Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format.

FIG. 2 is a flowchart illustrating processing steps 30 of the present disclosure. First, in step 32, a set of high-level constructs are defined that could be predictive of the target and could be built from the underlying data. It is not required during this step to know the actual predictive power of each construct, or even whether a given construct has any predictive power at all, because the best ones will be selected at a later stage of modeling. Some constructs may be time-dependent: for example, the time window between one specified medical event and another (FIG. 3), or a defined time period following a particular medical event (FIG. 4), or the time period before a particular medical event occurred (pre-event history, FIG. 5). Focusing on a limited time window is necessary because relevant information for each construct is concentrated within the time window and inclusion of data outside that time window would dilute the predictive power of the information within it.

Other constructs may capture structural information implicit in the underlying data. For instance, the raw data may record a variable number of ICD9 diagnostic codes for a particular medical procedure, but the first position in the list may be reserved for the patient's reported symptoms, while the second is reserved for the doctor's diagnosis. Some high-level constructs may capture hierarchical information in the underlying data.

For instance, patient residence and medical facility ZIP codes are hierarchically organized from the leftmost to rightmost digits, allowing simultaneous capture of information at different levels in a set of high-level constructs. The underlying data may also contain prescription drug classification descriptors that are hierarchical, allowing simultaneous capture, in different high-level constructs, of both broad drug class and specific medications.

The definition of all high-level constructs must be clear and explicit in order to allow their calculation from the underlying data, but they have the advantage of easily and naturally taking into consideration complexities of the problem that is being modeled. For example, a given high-level construct might be defined on the time window (e.g., defined, variable, fixed, etc.) from a particular medical event to a particular date on which model results are regularly updated—e.g., first of each month (FIG. 6). Although the modeling data may actually contain all historical information, there could be a complex logic to define which information is known at a particular modeling date due to reporting latencies. The high-level constructs defined using the time window above can and must take these reporting latencies into account, to make sure that no information is used before it would have been known. Having defined a set of high-level constructs built upon the underlying data, the next step 34 carried out by the system calculates smoothed and thresholded WoE tables for each high-level construct in the data.

Then in step 36, the Evidence Ranked Sum (ERS) is calculated (using the ERS method to calculate a single scalar value using the WoE tables) for each instance of each high-level construct in the data. These continuous scalar values distill in one place all of the contributions to the target prediction from a variable number of records in the underlying data, and comprehensively and systematically capture all of the target information from all of the field values that are marginally but significantly predictive. Then in step 39, predictive models are built for the target based on ERS values constructed from the data.

Potential products, processes, services, or research tools based on the disclosure include any product that involves estimating probabilities of healthcare outcomes using categorical data in patient medical records. Many possible examples are described elsewhere in this disclosure. Processes would flag patients determined to be at elevated risk of future preventable, treatable conditions, allowing timely intervention and leading to reduced healthcare costs and improved patient health. Services would be based on the above products and processes. The methods described in this disclosure would also be used as part of the research tools used to build the models that implement such products and services. Examples of patient or consumer base for such products, processes, services, or research tools include hospitals and other medical facilities, healthcare insurance providers and payers, companies that provide healthcare to their employees, government healthcare services, and many others. There are many companies and/or institutions that could be interested in developing such products, processes, services, or research tools.

The evidence ranked sum methodology is utilized by the system of the present disclosure. At the foundation of the ERS method is Weight of Evidence (WoE), such as disclosed in I. J. Good, “Probability and the Weighing of Evidence,” Griffin, London (1950) and I. J. Good, et al. “Information, Weight of Evidence: The Singularity Between Probability Measures and Signal Detection,” Springer (1974), the entire disclosures of which are incorporated herein by reference. Consider a set of N observations of a categorical variable with n_{c} possible values, and a binary target which takes on values “good” or “bad”. The Weight of Evidence for category c of the variable is:

$${WoE}_{c} = ln [ \frac{{G}_{c} / G}{{B}_{c} / B} ] \qquad Equation 1$$

where G_{c} is the number of “goods” in category c, B_{c} is the number of “bads” in category c, G=Σᵢ₌₁ⁿ^{_{c}}Gᵢ is the total number of “goods”, and B=Σᵢ₌₁ⁿ^{_{c}}Bᵢ is the total number of “bads.” Each category c can be thought of being a “slice” of the data (e.g., the subset of all observations that fall into category c). The numerator of the logarithm in Equation 1 is the fraction of all the goods that fall into category c, and the denominator is the fraction of all the bads that fall into category c. Note that if slicing the dataset by category c is completely independent of the target (e.g., no information between that slicing and the target), then the slice corresponding to category c is expected on average to contain an equal proportion of the goods and bads, and the WoE for category c will be zero. For example, if the slice for category c is 10% of all the observations, then it is expected that 10% of all the goods and 10% of all the bads are in category c. Conversely, if it is observed that the slice corresponding to category c is enriched or depleted in goods or bads (that the relative proportions of goods and bads in category c differ from 10%) then slicing by this category is not independent of the target. A negative WoE value for category c indicates that the proportion of bads is enriched in that category, and a positive WoE indicates that the proportion of goods is enriched.

In calculating WoE on real data using Equation 1, problems could occur if the empirical counts of goods or bads in any category c are too low, since Equation 1 is blind to uncertainties due to sampling statistics. Low counts could lead to large errors in our estimates of WoE for categories with low counts. Those effects are mitigated by extending the concept of WoE to a smoothed form (e.g., smoothed weight of evidence):

$${WoE}_{c} = ln [ \frac{{G}_{c} + {KP}_{G}}{{\sum }_{i = 1}^{{n}_{c}} ( {G}_{i} + {KP}_{G} )} ] - ln [ \frac{{B}_{c} + {KP}_{B}}{{\sum }_{i = 1}^{{n}_{c}} ( {B}_{i} + {KP}_{B} )} ] = ln [ \frac{{G}_{c} + {KP}_{G}}{G + {n}_{c} {KP}_{G}} ] - ln [ \frac{{B}_{c} + {KP}_{B}}{B + {n}_{c} {KP}_{B}} ] \qquad Equation 2$$

where P_{G}=G/N is the overall probability of “good” across all categories, P_{B}=B/N is the overall probability of “bad” across all categories, and K>0 is a smoothing parameter. Note that if K→0, this expression just reduces to that of Equation 1. At the other extreme, as K becomes very large compared to G and B, WoE_{c}→0 as the large K overwhelms any differences in counts between categories and pulls all category counts toward the population average. At moderate values of K between these extremes, Equation 2 gives a “smoothed” WoE that selectively pulls categories with low counts toward the population average, while preserving target information that is robustly represented by high counts.

Next, the training data is used to build a smoothed and thresholded WoE table for each high-level construct that has been defined. Consider an example using ICD9 diagnostic codes and a fixed time window extending from the date of a given type of medical event until 14 days after it. For each instance of that type of medical event in the training data, all of the ICD9 diagnostic codes (and/or all categorical data, such as all relevant patient categorical data in the relevant high-level construct) in the data that fall within the fixed-length window (e.g., defined, fixed variable, etc.) would be included in the WoE table. Alternately, consider a scenario where the model scores all qualifying patients at the beginning of each month, and included in the WoE table are the ICD9 diagnostic codes in all records between the date of the medical event and the modeling date of which the system would have been aware at the modeling date given some possibly complex logic of reporting latencies. Note that a WoE table can be built on any high-level construct that is clearly defined.

The WoE tables have a count threshold T for inclusion of an enumerated value (i.e., category c) in the table. Entries for those values that appear at least once in the training data but whose counts are below threshold are dropped. Only those values that have sufficient counts in the training data to be statistically important are desired to be retained. This is done for computational and storage efficiency, even though using smoothed WoE mitigates any problems from categories with low counts.

The evidence ranked sums are calculated by the system of the present disclosure. The WoE tables are used to convert each categorical value in each instance of each high-level construct into a list of numerical WoE values. Of course, not every categorical value in the data will be found in the WoE tables, since not all possible values will have counts above threshold T. Categorical values not found in the WoE tables get a WoE of zero, since there is no significant target information. For each instance of each high-level construct in the data, there is now a variable-length list of WoE values. In most cases the majority of items on each list will have small WoE values. A minority may have large WoE values.

First, the WoE entries in the list are ranked for each instance of each high-level construct in descending order by absolute value of WoE. Rank is by absolute value because at this stage the magnitude of the predictive value for the target is more important than about the direction of the prediction. Obviously, the system wants to retain the most significant entries on the WoE list for each instance of each high-level construct, but needs to handle the variable-length tail of small WoE values. The combined effect of several small WoE values are expected to possibly have predictive value, but the system also needs to normalize against the bias of longer lists having more values. To avoid target leakage, test data is not used in building the tables. Therefore a fixed-length list of M WoE values for every construct is made. If a given instance of a high-level construct in the data has fewer than M WoE entries when ranked in descending order by |WoE|, the remaining least-significant entries are set to zero, reflecting lack of additional information relevant to the target.

Finally, the list of M WoE values is summed to obtain a single scalar ERS value for each instance of each high-level construct in the data. Importantly, the signs of all WoE values in these sums are retained. It could happen that a particular construct instance has both significant positive and negative WoE entries, making opposite predictions for the target. In that case, these WoE values are expected and desired to partially cancel each other. Each ERS variable constructed as described above is a single scalar value that can be calculated for train, validation, and test sets and then used directly in modeling.

There are several ways the ERS methodology may be extended. One way is to use a validation set to optimize ERS meta-parameters. It is common practice to use a separate validation dataset to optimize model meta-parameters such as the number of layers and hidden units for neural network models. The same approach can be used to optimize parameters of high-level ERS constructs such as the lengths of time windows in the healthcare example discussed above. More importantly, the core meta-parameters of the ERS methodology can also be optimized this way. These include the smoothing parameter K, the count threshold T for inclusion of an enumerated value in WoE tables, and M for the length of the WoE list to sum.

Another way is extension to continuous non-categorical data by binning. The ERS methodology as described is only applicable to categorical data, but could be easily extended to continuous data by breaking that data up into discrete bins. The exact binning may for some problems be informed by domain knowledge. It is also possible in principle to treat the binning as meta-parameters to be optimized by means of a validation set as discussed above.

Yet another way is extension to non-binary classification models. The weight of evidence tables on which the ERS methodology is built, as described here, apply only to binary classification problems. However, the concept of WoE can be extended to targets with more than two classes by adding another index onto the WoE tables that describes the target category. So, for example, if the target values are “red,” “green,” and “blue,” a WoE value for category c and target “red” can be calculated. All of the other calculations extend straightforwardly as well.

FIG. 7 is a diagram showing hardware and software components of a computer system 100 on which the system of the present disclosure could be implemented. The system 100 comprises a processing server 102 which could include a storage device 104, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The server 102 could be a networked computer system, a personal computer, a smart phone, tablet computer etc. It is noted that the server 102 need not be a networked server, and indeed, could be a stand-alone computer system.

The functionality provided by the present disclosure could be provided by a healthcare outcome prediction program/engine 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single- or multiple-core microprocessor of any suitable architecture that is capable of implementing and running the healthcare outcome prediction program 106 (e.g., Intel processor). The random access memory 114 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected is set forth in the following claims.

What is claimed is:

1. A system for healthcare outcome predictions using medical history categorical data comprising:
a computer system for receiving medical history categorical data;
a healthcare outcome prediction engine stored on the computer system which, when executed by the computer system, causes the computer system to:
process the medical history categorical data to define a set of high-level constructs;
calculate smoothed and thresholded Weight of Evidence tables for each high-level construct using training data;
calculate an Evidence Ranked Sum value for each instance of each high-level construct based on the Weight of Evidence tables; and
build predictive models based on the calculated Evidence Ranked Sum values.

2. The system of claim 1, wherein the medical history categorical data comprises ICD9 diagnostic and procedure codes.

3. The system of claim 1, wherein one or more of the high-level constructs are time-dependent.

4. The system of claim 1, wherein for each instance of a type of medical event in the training data, all categorical data within a time window are included in the Weight of Evidence tables.

5. The system of claim 1, wherein any values in the training data with counts below a threshold are dropped from the Weight of Evidence tables.

6. The system of claim 1, wherein the Evidence Ranked Sum value is a single scalar value summed from a list of Weight of Evidence values.

7. A method for healthcare outcome predictions using medical history categorical data comprising:
receiving at a computer system medical history categorical data;
processing the medical history categorical data using a healthcare outcome prediction engine executed by the computer system to define a set of high-level constructs built from medical history categorical data;
calculating using the healthcare outcome prediction engine smoothed and thresholded Weight of Evidence tables for each high-level construct using training data;
calculating using the healthcare outcome prediction engine an Evidence Ranked Sum value for each instance of each high-level construct based on the Weight of Evidence tables; and
building predictive models using the healthcare outcome prediction engine based on the calculated Evidence Ranked Sum values.

8. The method of claim 7, wherein the medical history categorical data comprises ICD9 diagnostic and procedure codes.

9. The method of claim 7, wherein one or more of the high-level constructs are time-dependent.

10. The method of claim 7, wherein for each instance of a type of medical event in the training data, all categorical data within a time window are included in the Weight of Evidence tables.

11. The method of claim 7, wherein any values in the training data with counts below a threshold are dropped from the Weight of Evidence tables.

12. The method of claim 7, wherein the Evidence Ranked Sum value is a single scalar value summed from a list of Weight of Evidence values.

13. A non-transitory computer-readable medium having computer-readable instructions stored thereon which, when executed by a computer system, cause the computer system to perform the steps of:
receiving at the computer system medical history categorical data;
processing the medical history categorical data using a healthcare outcome prediction engine executed by the computer system to define a set of high-level constructs built from medical history categorical data;
calculating using the healthcare outcome prediction engine smoothed and thresholded Weight of Evidence tables for each high-level construct using training data;
calculating using the healthcare outcome prediction engine an Evidence Ranked Sum value for each instance of each high-level construct based on the Weight of Evidence tables; and
building predictive models using the healthcare outcome prediction engine based on the calculated Evidence Ranked Sum values.

14. The computer-readable medium of claim 13, wherein the medical history categorical data comprises ICD9 diagnostic and procedure codes.

15. The computer-readable medium of claim 13, wherein one or more of the high-level constructs are time-dependent.

16. The computer-readable medium of claim 13, wherein for each instance of a type of medical event in the training data, all categorical data within a time window are included in the Weight of Evidence tables.

17. The computer-readable medium of claim 13, wherein any values in the training data with counts below a threshold are dropped from the Weight of Evidence tables.

18. The computer-readable medium of claim 13, wherein the Evidence Ranked Sum value is a single scalar value summed from a list of Weight of Evidence values.
